(19) United States
(12) Patent Application Publication
(10) Pub. No.: US 2023/0385675 A1
(43) Pub. Date: Nov. 30, 2023

(54) QUANTUM REINFORCEMENT LEARNING FOR TARGET QUANTUM SYSTEM CONTROL

(71) Applicant: ColdQuanta, Inc., Boulder, CO (US)

(72) Inventors: Eric Brandon Jones, Golden, CO (US); Dana Zachary Anderson, Boulder, CO (US)

(21) Appl. No.: 18/203,481

(22) Filed: May 30, 2023

Related U.S. Application Data
(60) Provisional application No. 63/346,943, filed on May 30, 2022.

(51) Int. Cl. G06N 10/20; G06N 3/092

(52) U.S. Cl. CPC G06N 10/20; G06N 3/092

(57) ABSTRACT

A quantum sensor including a training agent and a target quantum system is described. The target quantum system includes quantum state carriers that are capable of being mutually entangled. The training agent includes a training quantum system. The target quantum system receives a control input. An output in response to the control input is obtained from the target quantum system. The training agent evaluates the output and determines a subsequent control input for the target quantum system.

### CROSS REFERENCE TO OTHER APPLICATIONS

This application claims priority to U.S. Provisional Patent Application No. 63/346,943 entitled QUANTUM REINFORCEMENT LEARNING FOR STRONGLY-CORRELATED QUANTUM SENSOR CONTROL filed May 30, 2022, which is incorporated herein by reference for all purposes.

### BACKGROUND OF THE INVENTION

Quantum systems utilize aspects of the quantum information of quantum state carriers in order to perform various functions. For example, quantum sensors induce transformations on the wave function for a quantum system's quantum state carriers (e.g. neutral atoms or ions) through a controlled process. The property desired to be sensed is inferred from the transformed wave function. For example, in a matter wave interferometer, atomic trajectories are split into counterpropagating beams, or momentum eigenstates, and then subsequently recombined after a period of free propagation. Based upon the interference pattern of the recombined atoms (recombined matter waves), an aspect of the surroundings to which the quantum system has been exposed can be determined. For example, the acceleration(s) to which the counterpropagating beams of matter waves have been exposed may be sensed. Similarly, a quantum radio frequency (RF) electromagnetic field detector excites atoms to high energy states (e.g. Rydberg states) and exposes the atoms to RF electromagnetic fields. For some frequencies of RF electromagnetic fields, atoms undergo transitions to particular lower energy states. Based upon the populations of atoms in various energy states, RF electromagnetic fields of particular frequencies may be detected.

Although quantum sensors offer advantages, their operation is desired to be optimized. For example, sensitivity to the target signal is desired to be enhanced, while the response to noise or extraneous signals is desired to be diminished. However, the relevant degrees of freedom of the quantum system may not be known in advance. Further, quantum systems may involve large numbers of quantum state carriers having complicated states and/or mutual interactions. This makes explicit a determination of the optimized state of the quantum system challenging. Consequently, optimization of such systems may be limited in scope and inefficient to carry out. Accordingly, an improved technique for utilizing quantum systems, for example in the context of quantum sensors, is desired.

### BRIEF DESCRIPTION OF THE DRAWINGS

Various embodiments of the invention are disclosed in the following detailed description and the accompanying drawings.

FIG. 1 depicts an embodiment of a system for training a quantum system.

FIG. 2 is a flow chart depicting an embodiment of a method for training a quantum system.

FIG. 3 depicts another embodiment of a system for training a quantum sensor.

FIG. 4 depicts another embodiment of a system for training a quantum sensor.

FIG. 5 is a flow chart depicting an embodiment of a method for training a quantum sensor utilizing semiclassical data.

FIG. 6 is a flow chart depicting an embodiment of a method for training a quantum sensor utilizing quantum data.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Quantum systems utilize information related to the quantum state carriers in order to perform various functions. A quantum state carrier has quantum information related to the wave function describing the quantum system. In some cases, quantum state carriers may be particles. For example, quantum state carriers may include neutral atoms and/or ions. The quantum information might relate to the internal state of individual quantum state carriers (e.g. the energy levels of an atom), to external quantum mechanical phenomenon (e.g. matter waves formed by the atoms), and/or to other quantum mechanical aspects of the quantum system.

Quantum sensors include quantum systems used to sense one or more properties of the surroundings (“ambient”). To perform the sensing function, the quantum information of the quantum state carriers is used. In particular, the state of the quantum state carriers may be transformed and the property or properties of the ambient sensed based on the transformation. In order to perform this or other functions, the behavior of the quantum system is desired to be optimized for its function. For example, sensitivity of the quantum sensor to the target signal may be desired to be enhanced. The response of the quantum sensor to noise or extraneous signals may be desired to be diminished. However, the nature of the quantum sensors makes providing the desired sensitivity and/or training the quantum sensor challenging and inefficient.

For example, one conventional optimization method for quantum sensors performs the optimization experimentally. In this case, the calculation of all the necessary observables for the optimization may be highly inefficient or impossible. Another conventional optimization method simulates the quantum process classically. This conventional optimization may only be tractable for some quantum systems and may only be viable in the weakly-interacting limit. Quantum sensors are therefore typically confined to a weakly-interacting operating regime and the optimization performed via cost functions utilizing semiclassical observables. This furnishes a limited representation of the underlying Hilbert space of the quantum sensor. Thus, constraining quantum sensors to operate in the weakly-interacting regime severely limits their potential applications.

A technique for training a target quantum system, such as for a quantum sensor, is described. The target quantum system includes quantum state carriers that are capable of being mutually entangled. For example, the target quantum system may include a shaken lattice and/or a quantum radio frequency (RF) electromagnetic field detector having atoms excited to Rydberg states. Some or all of the atoms in the shaken lattice and/or the Rydberg atoms may be entangled. A training agent that includes a training quantum system is utilized. For example, the training quantum system may include a quantum neural network and/or a quantum computer. The target quantum system receives a control input. An output in response to the control input is obtained from the target quantum system. The training agent evaluates the output and determines a subsequent control input for the target quantum system. The training agent may be considered part of or separate from the quantum sensor.

Utilizing the training agent having the training quantum system may improve performance of the quantum system. For example, the training quantum system may improve the efficiency of the optimization of the quantum system having entangled and/or strongly correlated quantum state carriers. This facilitates the use of quantum systems, such as quantum sensors, having highly correlated quantum state carriers. Correlated quantum state carriers may result in a higher signal to noise ratio (SNR), which is desirable. Further, noise may be suppressed and/or the underlying performance of the quantum system may be enhanced by allowing optimization of the quantum system to a different region of Hilbert space. Consequently, efficiency of optimization and performance of the underlying quantum system may be improved.

To evaluate the output and determine the subsequent control input the training agent performs reinforcement learning. The subsequent control input may reflect that the training agent has received a reward due to a desired characteristic of the output. The subsequent control input may reflect that the training agent has been penalized due to an undesired characteristic of the output. The training agent may cause some or all of the quantum state carriers to become entangled.

In some embodiments, the output from the target quantum system is obtained such that quantum information in the output is retained. For example, the output can be transduced from the target quantum system to the training agent.

In some embodiments, a quantum sensor including a target quantum system is described. The target quantum system includes quantum state carriers capable of being mutually entangled. The target quantum system receives a control input and provides an output based on the control input. For such a quantum sensors, a training agent coupled with the target quantum system obtains the output from the target quantum system, evaluates the output, and determines a subsequent control input for the target quantum system based on the output. The training agent has a training quantum system, which includes a quantum computer and/or a quantum neural network. The subsequent control input is provided to the target quantum system. To evaluate the output and determine the subsequent control input, the training agent performs reinforcement learning. The subsequent control input augments a desired characteristic of the output or reduces an undesired characteristic of the output.

A method for optimizing a quantum sensor is described. The quantum sensor includes a target quantum system having a plurality of quantum state carriers capable of being mutually entangled. The method includes obtaining, at a training agent, an output of a target quantum system. The output is based on a control input received by the target quantum system. The training agent includes a training quantum system. Using the training quantum system, the training agent evaluates the output. Based on the evaluation and using the training quantum system, the training agent determines a subsequent control input for the target quantum system. The subsequent control input augments a desired characteristic of the output or reduces an undesired characteristic of the output. Through training, the training agent may cause at least a portion of the quantum state carriers to become correlated. In some embodiments, obtaining the output includes obtaining the output from the target quantum system such that quantum information in the output is retained. This may be accomplished by transducing the output from the target quantum system to the training agent. In some embodiments, the method also includes providing the subsequent control input to the target quantum system. A subsequent output of the target quantum system is based on the subsequent control input. The method also includes repeating the obtaining, evaluating, and determining for the subsequent output of the target quantum system.

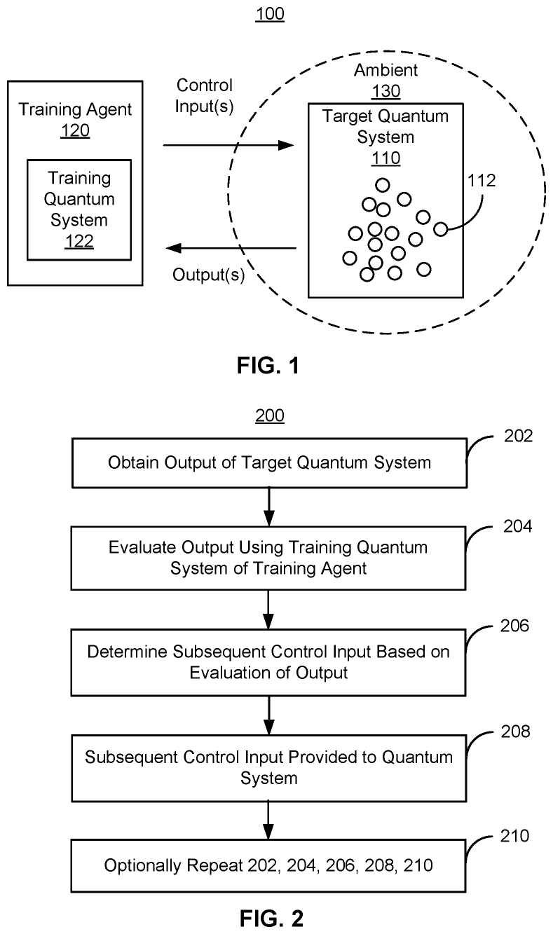

FIG. 1 depicts an embodiment of system 100 for training target quantum system 110 utilizing training agent 120. In some embodiments, system 100 may be or include a quantum sensor. For example, the quantum sensor might be a matter wave interferometer (e.g. a shaken lattice interferometer), a shaken lattice accelerometer, a quantum radio frequency (RF) electromagnetic field detector, a quantum clock, and/or another sensor that utilizes a quantum system to measure properties of ambient (i.e. the surroundings) 130.

Target quantum system 110 includes quantum state carriers 112, of which only one is labeled. Quantum state carriers 112 may include or be quantum particles such as atoms and/or ions. Further, quantum state carriers 112 are capable of being mutually entangled. In some embodiments, some or all of quantum state carriers 112 are entangled prior to training. In some embodiments, some or all of quantum state carriers 112 may become entangled during training. A first quantum state carrier that is entangled with a second quantum state carrier has a wave function that carries quantum information about the second quantum state carrier. Measurement of the state of the first quantum state carrier determines or is determined by measurement of the state of the second quantum state carrier. Consequently, entangled quantum state carriers 112 are correlated.

Training agent 120 is an intelligent agent used in performing machine learning and includes training quantum system 122. Training quantum system 122 may be a quantum computer, a quantum neural network and/or other quantum system. Thus, training quantum system 122 includes training quantum state carriers (not shown in FIG. 1). Such training quantum state carriers may be neutral atoms or ions in some embodiments. In some embodiments, training quantum state carriers takes another form.

For clarity, only some portions of system 100 are shown. For example, target quantum system 110 may include lasers, photodetectors, mechanisms for generating electric and/or magnetic fields, control electronics and/or other components in operating target quantum system 110 but which are not explicitly depicted. These components may be specific to the functioning of the quantum sensor and/or target quantum system 110. For example, for a shaken lattice interferometer, target quantum system 110 may include components for forming an optical lattice in which quantum state carriers 112 are trapped, for phase modulating (i.e. shaking) the optical lattice, and for reading a resulting interference pattern. In another example, for a quantum RF electromagnetic field detector, target quantum system 110 may include lasers for exciting the quantum state carriers 112 to high energy states (e.g. Rydberg states), an electric field generator for inducing a Stark shift and/or modulating the electric field, and a photodetector or other mechanism for determining the energy transitions quantum state carriers 112 undergo in response to incident RF electromagnetic fields.

Similarly, training agent 120 may include components that are not shown for clarity. For example, training agent 120 may include a classical computer or other mechanism for interfacing with training quantum system 122 as well as laser and other systems for manipulating training quantum state carriers (not shown in FIG. 1) that are used in training quantum system 122. In addition, components may be used to allow the communication of information between target quantum system 110 and training agent 120. For example, control input(s) may be provided from training agent 120 via electrical connection to lasers and/or other components of target quantum system 110. Optical cables or other components may allow for output(s) to be provided from target quantum system 110 to training agent 120.

Training agent 120 utilizes reinforcement learning for training target quantum system 110. Target quantum system 110 may thus be considered the environment for training agent 120. Training agent 120 may be able to operate without an explicit model of the dynamics of target quantum system 110. This is desirable because classically simulating a quantum process on strongly-correlated degrees of freedom of target quantum system 110, if possible, in some instances, may not be scalable. Further, reinforcement learning allows training agent 120 to contend with stochasticity in the quantum processes of target quantum system 110. Moreover, reinforcement learning performed by training agent 120 may allow the use of raw, potentially high-dimensional, data from target quantum system 110.

In operation, target quantum system 110 receives one or more control inputs. The control input is related to the transformation of the quantum state of quantum state carriers 112. For example, the control input may be a shaking function used to modulate the optical lattice of a shaken lattice sensor, the laser light used to excite atoms to higher energy states, and/or other inputs. In response, target quantum system 110 provides an output. In some embodiments, the output is measured. For example, the interferometry pattern of a shaken lattice, the photons emitted by transitions between energy levels upon exposure of quantum state carriers 110 to RF electromagnetic fields, and/or other information related to the response of target quantum system 110 to the control input(s). In some embodiments, the state of target quantum system 110 is not measured.

The output of target quantum system 110 is obtained by training agent 120. In some embodiments, the output obtained by training agent 120 includes semiclassical information. The semiclassical information may be generated by a measurement of the quantum state of quantum state carriers 112. In some embodiments, quantum information related to quantum state carries is transferred to training agent 120. For example, quantum data for quantum state carriers 112 may be transduced directly to training quantum system 122. However, transduction typically includes a change in form of the quantum data (e.g. from matter waves in target quantum system 110 to the energy state of individual atoms/ions in training quantum system 120). In some embodiments, the quantum data is transferred from target quantum system 110 to training quantum system 122 without a change in form (e.g. from matter waves to matter waves or from atomic energy state to atomic energy state).

Training agent 120 evaluates the output and determines a subsequent control input for target quantum system 110. To do so, training agent 120 may compare the output to desired behavior of target quantum system 110. For example, training agent 120 using training quantum system 122 may determine whether the sensitivity of the output is above a threshold, the noise in the output is below a threshold, or whether extraneous signals (e.g. gravity for an accelerometer or RF electromagnetic fields of other frequencies for an RF detector) are sufficiently filtered. Based on this evaluation, subsequent control input(s) are determined by training agent 120. More specifically, rewards may be associated with desired behavior (e.g. improved sensitivity) and penalties associated with undesirable behavior (e.g. increased noise). The reward or penalty to training agent 120 is incorporated into the new subsequent control input(s). The subsequent control input(s) are provided to target quantum system 110. This process may be iteratively repeated by system 100. In some embodiments, multiple rounds of transformations are performed by target quantum system 110 after control input(s) are provided and the output obtained by training agent 120.

Because training agent 120 utilizes training quantum system 122, the properties of training agent 120 may better match target quantum system 110. This may provide benefits for training target quantum system 110 in both efficiency and the ability to reach an optimized state. Moreover, target quantum system 110 may include entangled quantum state carriers 112. Training agent 120 may be capable of optimizing the behavior of a system including entangled and/or correlated quantum state carriers 112. As a result, the SNR of the corresponding quantum sensor may be improved. Further, the training process itself may be made more efficient and less time consuming.

FIG. 2 is a flow chart depicting an embodiment of method 200 for training a target quantum system utilizing a training agent. For simplicity, some steps may be omitted. In some embodiments processes may be combined and/or performed in another order (including in parallel). Method 200 is also described in the context of system 100. In some embodiments, method 200 may be applied to other systems.

The output of a target quantum system is obtained by the training agent, at 202. The output is formulated by the target quantum system in response to a control input that is received by the target quantum system. In some embodiments, the target quantum system may perform multiple iterations of its processes before providing the output. The output includes quantum information about the target quantum system. In some embodiments, the output obtained is quantum information embedded in quantum data. In such embodiments, the information may be transduced or directly transferred (without a change in form) to the training quantum system. In some embodiments, the output is semiclassical in nature and may be obtained by a measurement of the quantum state carriers in the quantum system.

Using the training quantum system, the output is evaluated, at 204. For example, the noise, signal amplitude, sensitivity, and/or bandwidth may be compared to benchmarks. Based on the evaluation, a subsequent control input for the quantum system is determined at 206 and provided to the quantum system, at 208. The subsequent control input may be configured based on the agent being rewarded for desired behavior of system 100 and punished for undesirable behavior. Method 200 may be repeated, at 210, until the desired performance is obtained.

For example, an output from target quantum system 110 is received by training agent 120, at 202. Training agent 120 evaluates the output and determines a subsequent control input for target quantum system 110 and 204 and 206. Based on this evaluation, subsequent control input(s) are determined by training agent 120. The subsequent control input(s) are provided to target quantum system 110, at 208. This process may be iteratively repeated by system 100 at 210. In some embodiments, multiple rounds of transformations are performed by target quantum system 110 after control input(s) are provided and the output obtained by training agent 120.

Using method 200, systems, such as quantum sensors, may be more efficiently trained and better performance attained. In particular, the benefits described herein with respect to system 100 may be achieved. Although efficiency and the ability to reach an optimized state are improved, method 200, as well as system 100, do not ensure that quantum system 100 follows a particular trajectory through various states or that a particular final state is obtained. Instead, the reinforcement learning utilized to obtain desired behavior of target quantum system 110 and quantum sensor 100.

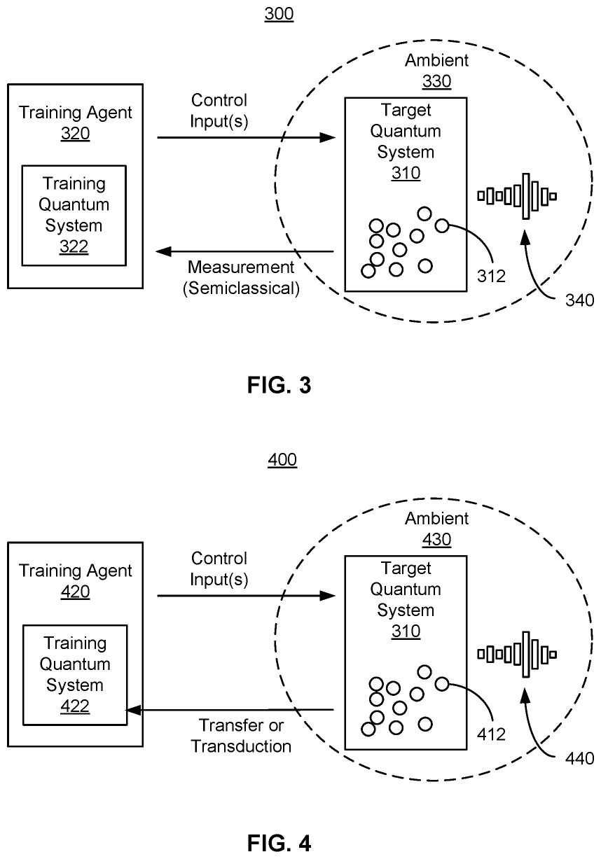

FIG. 3 depicts an embodiment of quantum system 300 for training a quantum sensor utilizing semiclassical data. Quantum system 300 is analogous to quantum system 100. Thus, quantum system 300 includes target quantum system 310 that may be exposed to ambient 330 as well as training agent 320 having training quantum system 322. Target quantum system 310, training agent 320, and training quantum system 322 are analogous to target quantum system 110, training agent 120, and training quantum system 122, respectively. Further, ambient 330 includes a signal 340 which is desired to be sensed. System 300 performs training in an analogous manner to system 100 and method 200.

Similarly, FIG. 4 depicts another embodiment of quantum system 400 for training a target quantum sensor utilizing quantum data. Quantum system 400 is analogous to quantum system 100. Thus, quantum system 400 includes target quantum system 410 that may be exposed to ambient 430 as well as training agent 420 having training quantum system 422. Target quantum system 310, training agent 420, and training quantum system 322 are analogous to target quantum system 110, training agent 120, and training quantum system 122, respectively. System 400 performs training in an analogous manner to system 100 and method 200. Ambient 430 includes a signal 440 which is desired to be sensed. System 400 performs training in an analogous manner to system 100 and method 200.

Systems 300 and 400 are analogous to each other. However, system 300 utilizes semiclassical data in training, while system 400 transfers (e.g. transduces or directly provides) quantum data to training quantum system 422 for use in training. The semiclassical quantum sensor data utilized in system 300 may be obtained via a measurement of target quantum system. Thus, the semiclassical quantum data furnishes a compressed representation of the Hilbert space for target quantum system 310. A quantum learner, such as a quantum neural network, may be more appropriate to infer elements of the dynamics of target quantum system 310 and to make conclusions about its optimal control. Thus, a quantum neural network may be employed for training quantum system 322.

Although semiclassical data may be used in conjunction with training agent 320 having training quantum system 322, further improvements can be achieved. In system 400, therefore, quantum data for target quantum system 410 is directly transferred (with no change in form) or transduced (with a change in form) into training quantum system 322. For example, the quantum data may be transferred or transduced to a noisy intermediate scale quantum (NISQ) computer memory that may be part of training quantum system 322. Learning routines may be performed on quantum post-processed data using quantum training agent 420. For example, any measurements on the quantum data may be performed by training agent 420. In some embodiments, a digital, NISQ computer may be utilized for training agent 420.

In some embodiments, features of the training agents 320 and 340, such as the types of hardware used for training quantum systems 322 and 422, may be specified based on the data received from the target quantum systems 322 and 422, the functions provided by the target quantum systems 322 and 422, and the type of reinforcement learning selected to be used. One technique for designing training agents 320 and 420 is described in the context of sensors.

The reinforcement learning degrees of freedom for quantum sensors may be specified as follows. Training agents undergo training over some number of episodes, Nₑₚ, each of which is of temporal length T=NₜΔt, where Δt=tᵢ₊₁−tᵢ is a discrete timestep and Nₜ is the number of timesteps in each episode. Meanwhile, the target quantum system (e.g. the quantum sensor, or environment,) is subject to an input signal θ. For example, θ may be an acceleration or rotation for a shaken lattice accelerometer. In some embodiments, the goal of the training agent is to learn the value of 0 with maximal precision. At each time tᵢ after initialization, the training agent is in some state s of its environment. In the instance of semiclassical data transfer (e.g. between target quantum system 310 and training agent 320), each state corresponds to a posterior probability distribution over random variable x given θ, that is, s=P(x|θ). For quantum data transduction, s=ρ(x|θ), where ρ is a quantum density matrix. The training agent takes an action, a, according to the protocol by which the training agent learns. For instance, in E-greedy Q-Learning, a is randomly chosen with probability ∈ and a=argmax·Q(s, a) with probability 1-∈, which helps the training agent balance exploration with optimization. Here, Q(s, a) is the action-value, or Q, function which indicates to the agent the expected future return of taking action a in state s. Therefore, the training agent can be seen as mapping input states to action-value functions. Each action is a set-point for the sensor control parameter(s) over timestep Δt: a=ϕ(Δt). The target quantum system of the sensor evolves the state s under the quantum process to obtain a new state: s′=ε[s;ϕ(Δt)], which is given as input to the training agent for the next timestep. The training agent also receives or calculates for itself a reward that tells it how instantaneously good its behavior was over the previous timestep. A good general-purpose reward function may be determined by assuming that the target quantum system is a quantum sensor and that the quantum sensor is desired to be maximally sensitive to θ after execution of the entire quantum process, E, over process duration, T. As such, one reward function may be: r=0 if tᵢ≠T and r=f(Iₓ(θ)), that is, the training agent receives zero reward for any of its actions until the terminal time at which point it receives some positive function of the classical or quantum Fisher information of the output distribution. The training agent seeks to maximize this terminal reward and so will try to evolve the target quantum system to the output distribution with maximal Fisher information (and thus sensitivity) with respect to θ. From the terminal output distribution, one can recover the input signal via Bayes' theorem: P(θ|x)=P(x|θ)P(θ)/P(x).

A classical deep learning agent is a neural network with a layer of Nᵢₙ input nodes, followed by L hidden layers, each of which has Nⱼ nodes where j∈{1, 2, . . . , L}, and an output layer comprised of Nₒᵤₜ nodes. A training quantum system is desired to be used in lieu of or in addition to the classical deep neural network (or other classical learning system) for the training agents described herein. Regardless of the method used to replace the classical neural network, and thus quantize the training agent (e.g. utilize a training quantum system in lieu of a classical training system), the input and output nodes are replaced by Nᵢₙ input qubits and Nₒᵤₜ output qubits. To control performance of a quantum sensor (e.g. the target quantum system), it should be determined how to manage sensor data input to the Nᵢₙ qubits and how to represent its output on the Nₒᵤₜ qubits. This generally depends upon the sensing application as well as the variant of reinforcement learning used by the training agent. Many quantum devices output measured semiclassical data in the form of probability distributions in some measurement basis: P(x|θ) (discussed above). A quantum computer, for example, outputs a probability distribution over bit strings. In the context of shaken lattice interferometry, for example, the semiclassical output distribution is over quantized momentum states of atoms in the optical lattice, that is, P(2ℏk_{L}n|Ω), where k_{L} is the wavenumber of the lattice, n∈ [symbol] , and Ω is an inertial signal. In the classical setting, each of the M probabilities of the lowest-lying (most relevant) momentum states are mapped into one of the M=Nᵢₙ input nodes of the training agent. In the quantum setting, the M most relevant momentum state probabilities can be mapped into a quantum state on Nᵢₙ=log₂ M qubits given a suitable state-preparation circuit.

Regarding data output from a training agent, some of the most highly-performant applications of classical reinforcement learning, including in the control of quantum processes, are based on a variant known as deep Q-Learning. In deep Q-Learning, the agent's output is the action-value, or Q(s, a), function. In the quantum setting, the Q function for the training agent should in some sense “reside” on the output qubits of the training agent. How exactly this manifests depends on the method used to quantize the agent (e.g. training quantum system 422). Viable reformulations of deep Q-Learning are available for noisy intermediate-scale quantum (NISQ) processors as well as well-defined deep quantum neural networks. Thus, training agents having training quantum systems may be formed by replacing classical deep neural network with a hardware-efficient variational (or classically-parametrized) quantum circuit. Stated differently, training agent 320 may utilize such a quantum circuit in training quantum system 322. In this scheme, environmental states are encoded into the qubits through a (possibly variational) state-preparation protocol, and subsequently, a classically-parametrized quantum circuit takes the role of function approximator: U₀(β)|0 [symbol] ^{Nin}. The action-value function is then calculated as an expectation value of an action-dependent operator, Q_{β}(s, a)= [symbol] 0|^{Nin}U^{†}ₛ(β)0·U₀(β)|0 [symbol] ^{Nin}, whose particular form will depend upon the environment. The variational parameters, β, are adjusted in a manner analogous to the weights and biases of a classical neural network (such as via gradient descent) to minimize a loss function between Q₂(s, a) and a running estimate of the expected return. Alternatively, a more sophisticated technique may be used in which quantum information is transferred or transduced to the training quantum system. This occurs in system 400. For example, information can be transferred to networks of qubits where propagation between layers occurs via entangling unitaries. Thus, training quantum system 422 may include a network of qubits in training quantum system 422 for which quantum data is loaded by entanglement. Regardless of the method used for quantization, the training agent 320 and/or 420 remains compatible with common methods to improve the stability of Q-Learning such as using a replay buffer and a target network.

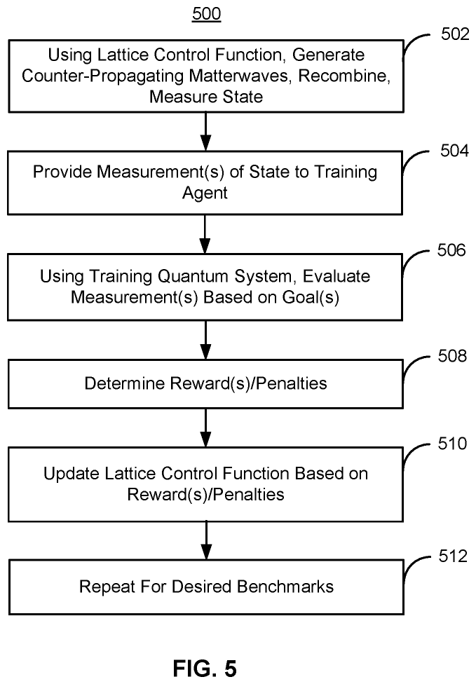

FIG. 5 is a flow chart depicting an embodiment of method 500 for training a quantum system utilizing semiclassical data. In particular, a shaken lattice interferometer is desired to be optimized using method 500. For simplicity, some steps may be omitted. In some embodiments processes may be combined and/or performed in another order (including in parallel). Method 500 is also described in the context of system 300. In some embodiments, method 500 may be applied to other systems.

A lattice control function is provided to the target quantum system, at 502. The target quantum system is configured to provide and control a collection of atoms in an optical lattice. Thus, counter-propagating matter waves may be generated, allowed to propagate, and recombined. The state of the recombined matter waves may also be measured at 502. Thus, the state of the target quantum system is determined by the measurement at 502.

At 504, the measurements are provided to the training agent. The measurements are semiclassical in nature. Using the quantum training system, the measurements are evaluated based on the goals, at 506. For example, if the shaken lattice interferometer is used as an accelerometer, the sensitivity may be desired to be maximized and the effects of gravity suppressed. Thus, the sensitivity may be compared to a previous measurement of acceleration and the background (i.e. gravity). Based on the evaluation, the rewards and/or penalties for the training agent are determined, at 508. The control function for the shaken lattice (target quantum system) is updated at 510 to incorporate the reward(s) and/or penalties. In some embodiments, 502, 504, 506, 508, 510 and 512 may be repeated until the desired performance is achieved.

For example, training agent 320 provides target quantum system 310 with a lattice control function in the presence of signal (i.e. acceleration) 340, at 502. Thus, the counter-propagating matter waves of target quantum system 310 experience acceleration 340. This acceleration 340 is also measured by determining the features of the recombined waves, at 502. This semiclassical information is provided from target quantum system 310 to training agent 320, at 504.

At 506, using quantum training system 322, the measurements are evaluated based on the goals of increased sensitivity to acceleration and reduced sensitivity to gravity, which is constant. Thus, the sensitivity may be compared to a previous measurement of acceleration and the background (i.e. gravity). Based on the evaluation, training agent 320 determines the rewards and/or penalties, at 508. Training agent 320 updates the control function for target quantum system 320, at 510. Thus, the reward(s) and/or penalties are incorporated into the function used to control the lattice. These processes may be repeated until the desired performance benchmarks are achieved.

Using method 500, quantum sensors, such as those utilizing shaken lattices, may be more efficiently trained and better performance attained. In particular, the benefits described herein with respect to system 100 may be achieved. Although efficiency and the ability to reach an optimized state are improved, method 500 does not ensure that quantum system 300 follows a particular trajectory through various states or that a particular final state is obtained. Instead, the reinforcement learning utilized to obtain desired behavior of target quantum system 310 and quantum sensor 300. However, because semiclassical information is used by the training agent, further improvements to performance may be achieved.

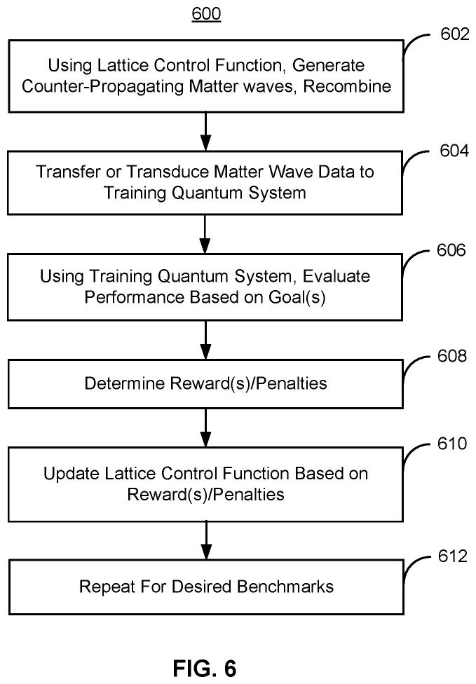

FIG. 6 is a flow chart depicting an embodiment of method 600 for training a quantum system utilizing transduced quantum data. In particular, a shaken lattice interferometer is desired to be optimized using method 600. For simplicity, some steps may be omitted. In some embodiments processes may be combined and/or performed in another order (including in parallel). Method 600 is also described in the context of system 400. In some embodiments, method 600 may be applied to other systems.

A lattice control function is provided to the target quantum system, at 602. The target quantum system is configured to provide and control a collection of atoms in an optical lattice. Thus, counter-propagating matter waves may be generated, allowed to propagate, and recombined.

At 604, the matter wave data for the shaken lattice is transduced to the training quantum system. Thus, quantum data is provided directly to the training agent. However, the form of the quantum data may be changed. Using the quantum training system, the performance represented by the quantum data is evaluated based on the goals, at 606. Thus, 606 is analogous to 506 of method 500. In some embodiments, 606 includes taking measurements of the data, which provide semiclassical information. In some embodiments, the evaluation may be performed on quantum data. Based on the evaluation, the rewards and/or penalties for the training agent are determined, at 608. The control function for the shaken lattice (target quantum system) is updated at 610 to incorporate the reward(s) and/or penalties. In some embodiments, 602, 604, 606, 608, 610 and 612 may be repeated until the desired performance is achieved.

For example, training agent 420 provides target quantum system 410 with a lattice control function in the presence of signal (i.e. acceleration) 440, at 602. Thus, the counter-propagating matter waves of target quantum system 410 experience acceleration 440. At 604, quantum data for the matter waves is transduced to training quantum system 422. For example, quantum state carriers in the recombined matter waves might be entangled with training quantum state carriers in training quantum system 422.

Using quantum training system 422, the performance of target system 610 as indicated by the quantum data is evaluated based on the goals of increased sensitivity to acceleration and reduced sensitivity to gravity, at 606. In some embodiments, 606 may involve quantum data, semiclassical data, or both. Based on the evaluation, training agent 420 determines the rewards and/or penalties, at 608. Training agent 420 updates the control function for target quantum system 420, at 610. Thus, the reward(s) and/or penalties are incorporated into the function used to control the lattice. These processes may be repeated until the desired performance benchmarks are achieved.

Using method 600, quantum sensors, such as those utilizing shaken lattices, may be more efficiently trained and better performance attained. In particular, the benefits described herein with respect to system 100 may be achieved. Although efficiency and the ability to reach an optimized state are improved, method 600 does not ensure that quantum system 400 follows a particular trajectory through various states or that a particular final state is obtained. Instead, the reinforcement learning is utilized to obtain desired behavior of target quantum system 410 and quantum sensor 400.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A quantum sensor, comprising:
a target quantum system including a plurality of quantum state carriers that are capable of being mutually entangled;
wherein the target quantum system receives a control input and wherein an output is obtained from the target quantum system in response to the control input; and
a training agent that evaluates the output and determines a subsequent control input for the target quantum system, wherein the training agent includes a training quantum system.

2. The quantum sensor of claim 1, wherein the target quantum system includes at least one of a shaken lattice including the plurality of quantum state carriers and a quantum radio frequency electromagnetic field detector.

3. The quantum sensor of claim 1, wherein at least a portion of the plurality of quantum is state carriers are entangled quantum particles.

4. The quantum sensor of claim 3, wherein the at least the portion of the plurality of quantum state carriers are strongly interacting.

5. The quantum sensor of claim 1, wherein the training agent includes at least one of a quantum neural network and a quantum computer.

6. The quantum sensor of claim 1, wherein to evaluate the output and determine the subsequent control input the training agent performs reinforcement learning.

7. The quantum sensor of claim 1, wherein the subsequent control input augments a desired characteristic of the output or reduces an undesired characteristic of the output.

8. The quantum sensor of claim 1, wherein the output from the target quantum system is obtained such that quantum information in the output is retained.

9. The quantum sensor of claim 8, wherein the output is transduced from the target quantum system to the training agent.

10. The quantum sensor of claim 1, wherein the training agent causes at least a portion of the quantum state carriers to become correlated.

11. A quantum sensor, comprising:
a target quantum system including a plurality of quantum state carriers capable of being mutually entangled, the target quantum system receiving a control input and providing an output based on the control input; and
wherein a training agent coupled with the target quantum system obtains the output from the target quantum system, evaluates the output, and determines a subsequent control input for the target quantum system based on the output, the training agent including a training quantum system, the training quantum system including at least one of a quantum computer and a quantum neural network, the subsequent control input being provided to the target quantum system.

12. The quantum sensor of claim 11, wherein to evaluate the output and determine the subsequent control input, the training agent performs reinforcement learning.

13. The quantum sensor of claim 11, wherein the subsequent control input augments a desired characteristic of the output or reduces an undesired characteristic of the output.

14. A method for optimizing a quantum sensor, comprising:
obtaining, at a training agent, an output of a target quantum system, the quantum sensor including the target quantum system, the target quantum system including a plurality of quantum state carriers that are capable of being mutually entangled, the output being based on a control input received by the target quantum system, the training agent including a training quantum system;
evaluating, by the training agent using the training quantum system, the output; and
determining, by the training agent using the training quantum system, a subsequent control input for the target quantum system based on the evaluating of the output.

15. The method of claim 14, wherein the subsequent control input augments a desired characteristic of the output or reduces an undesired characteristic of the output.

16. The method of claim 14, wherein the obtaining further includes:
obtaining the output from the target quantum system such that quantum information in the output is retained.

17. The method of claim 16, wherein the obtaining further includes:
transducing the output from the target quantum system to the training agent.

18. The method of claim 14, further comprising:
providing the subsequent control input to the target quantum system, a subsequent output of the target quantum system being based on the subsequent control input; and
repeating the obtaining, evaluating, and determining for the subsequent output of the target quantum system.

19. The method of claim 14, wherein the training agent causes at least a portion of the quantum state carriers to become correlated.
